(19) United States
(12) Patent Application Publication
(10) Pub. No.: US 2010/0291404 A1
(43) Pub. Date: Nov. 18, 2010

(54) LEAD-FREE HOT-DIP GALVANIZING METHOD AND PRODUCT

(76) Inventor: Chien-Tsung Ou, Pingtung County (TW)

Correspondence Address: Best International Patent & Trademark Office (USA), PO Box 220776, CHANTILLY, VA, 20153, US

(21) Appl. No.: 12/597,551

(22) PCT Filed: Apr. 27, 2007
(86) PCT No.: PCT/CN07/01411

§ 371 Date: Jan. 21, 2010

(51) Int. Cl. B32B 15/18; B05D 1/22

(52) U.S. Cl. 428/659; 427/433

(57) ABSTRACT

In a lead-free hot-dip galvanizing method and its processed product, a pure zinc tablet with a 99.995% purity is used and a conventional zinc solution containing lead is changed to a novel hot-dip galvanizing zinc solution for the hot dip galvanizing process. The hot-dip galvanizing zinc solution has a composition of 98% to 99% of zinc, 0.2% to 1.0% of aluminum and less than 1% of a trace element by weight, so that this hot dip galvanizing process with a lead and cadmium free galvanizing condition is achieved.

### BACKGROUND OF THE INVENTION

1. Field of Invention

The invention relates to the method of using a novel zinc solution for the hot-dip galvanizing process and its product in a lead and cadmium free environment to prevent the polluting of the environment during and after the hot-dip galvanizing anti-corrosion process.

2. Description of Related Art

In a conventional hot-dip galvanizing anti-corrosion process, an object coated with a fusing agent is dipped into a zinc solution at 450° C. to 520° C. To control the surface condition of a galvanized zinc layer, aluminum is added in a melted zinc solution, and lead is added to retard the rate of heat dissipation. A layer of dross will be formed on the surface of the melted zinc solution when the zinc solution is oxidized or when zinc and iron are hot-dip galvanized.

In general, a conventional zinc solution is composed of 96.4% zinc, 0.01% aluminum, 1.45% lead, 0.15% chromium and 1.95% of other element measured by weight.

Conventional zinc tablets used for a galvanizing process comply with the international standard ZISO/R752-1968, which is of an above-average grade, and contain approximately 1% of lead. Most galvanizing factories utilize a layer of lead at the bottom of the galvanizing bath, such that around 1.2% of lead is dissolved in zinc before the zinc solution is saturated. Traditional industry belief is that the galvanizing process becomes difficult if the lead concentration is below 0.5%.

However, the aforementioned conventional hot-dip galvanizing process has the following drawbacks:

1. Lead-Containing Manufacturing Process

Lead is a toxic substance, and the zinc tablets used in a conventional hot-dip galvanizing process contains lead. As a layer of lead is used at the bottom of a zinc bath furnace, subsequently products processed by the conventional hot-dip galvanizing process usually contain lead.

2. Environmental Pollution

Heavy metals contaminating the environment cannot be removed easily, and thus European Union Restriction of Hazardous Substances Directive (RoHS) has been established to prevent all traditional lead-containing products from entering the European market.

In view of the abovementioned shortcomings and subsequent results of the conventional hot-dip galvanizing process, the inventor of the present invention has developed a lead-free hot-dip galvanizing method and a lead-free hot-dip galvanized product to overcome the shortcomings of the prior art. This is achieved through years of experience in the related industry and extensive experiments and research.

### SUMMARY OF THE INVENTION

Therefore, it is the primary objective of the present invention to provide a lead-free hot-dip galvanizing method, wherein a conventional zinc solution containing lead is changed to a novel hot-dip galvanizing zinc solution for the hot dip galvanizing process. A special high grade (SHG) zinc tablet with a purity level of 99.995% is used for an improved zinc solution to overcome the heavy-metal lead contamination of the iron piece after the anti-corrosion treatment takes place.

Another objective of the present invention is to provide a technology for reducing the production of zinc dross (or waste material) significantly to improve the effects of the hot-dip galvanizing process as well as lower costs by 10% to 15%.

To achieve the foregoing objectives, the present invention provides a lead-free hot-dip galvanizing method and a lead-free finished product, wherein a special high grade (SHG) zinc tablet is used for a novel hot-dip galvanizing process, and a novel hot-dip galvanizing bath contains a zinc solution composed of 98 to 99% of zinc, 0.2 to 1.0% of aluminum and less than 1% of other element.

The present invention utilizes other metals to substitute the hazardous metal lead and achieves the effects of improving the chemical formula to reduce the production of zinc dross while saving costs. Most importantly, the hot-dip galvanized products are lead free, and present no harm to the environment, and minimize harm to human bodies.

### BRIEF DESCRIPTION OF THE DRAWINGS

The invention, as well as its many advantages, may be further understood by the following detailed description and drawings:

FIG. 1 is a flow chart of an operation procedure of the present invention; and

FIG. 2 is a product testing report of the present invention.

### DETAILED DESCRIPTION OF THE INVENTION

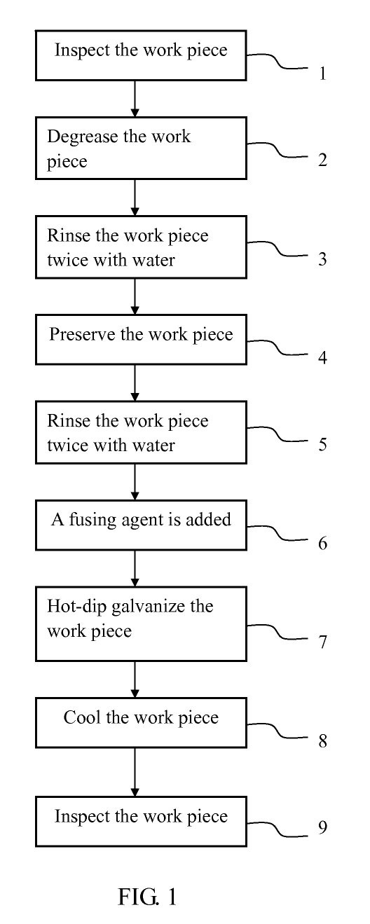

With reference to FIG. 1 for a flow chart of an operation procedure of the present invention, a pure zinc tablet made of special high grade (SHG) zinc, with a purity of 99.995% is used for the hot-dip galvanizing process. The present invention uses a novel hot-dip galvanizing bath containing 98 to 99% of zinc, 0.2 to 1.0% of aluminum and less than 1% of a trace element measured by weight. The trace element is composed of molybdenum, bismuth, silver, titanium and nickel.

In a work-piece inspection process 1, the surface of a work piece is inspected to check whether or not there is any oil stain, paint, reserve, zinc leak hole and damage. In a degreasing step 2, a degreasing agent with a pH value of 7 to 14 and a specific gravity of 1.04 to 1.09 is used for the degreasing process conducted at a temperature of 85° C. In a rinsing step 3, the work piece is rinsed twice by water with a pH value greater than 4. In a preserving step 4, the pickling process is held for an average of 20-40 minutes. In another rinsing step 5, the work piece is rinsed twice again. In a step of adding a fusing agent 6, the fusing agent 6 with a pH value ranging from 4.2 to 5 is added. In a hot-dip galvanizing step 7, a SHG zinc solution is used for carrying out the hot-dip galvanizing 7 at a temperature of approximately 80° C., wherein the temperature is maintained at 430° C.±30° C., and the temperature control inspection is conducted automatically. In a cooling step 8, the work piece is cooled after the hot-dip galvanizing 7 takes place. In the final inspection step 9, the work piece is inspected, so as to complete the production flow of the hot-dip galvanized products.

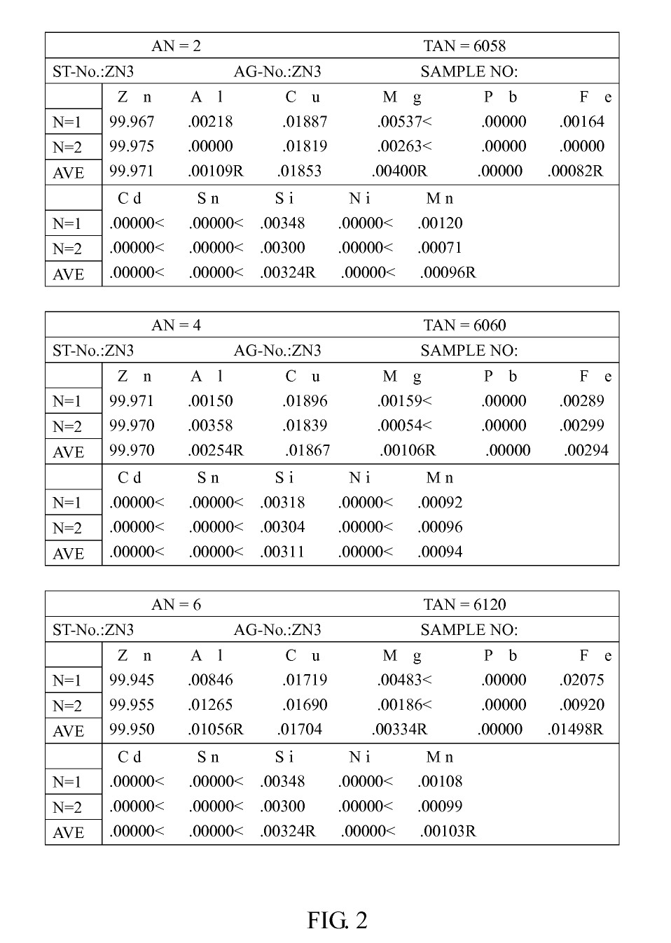

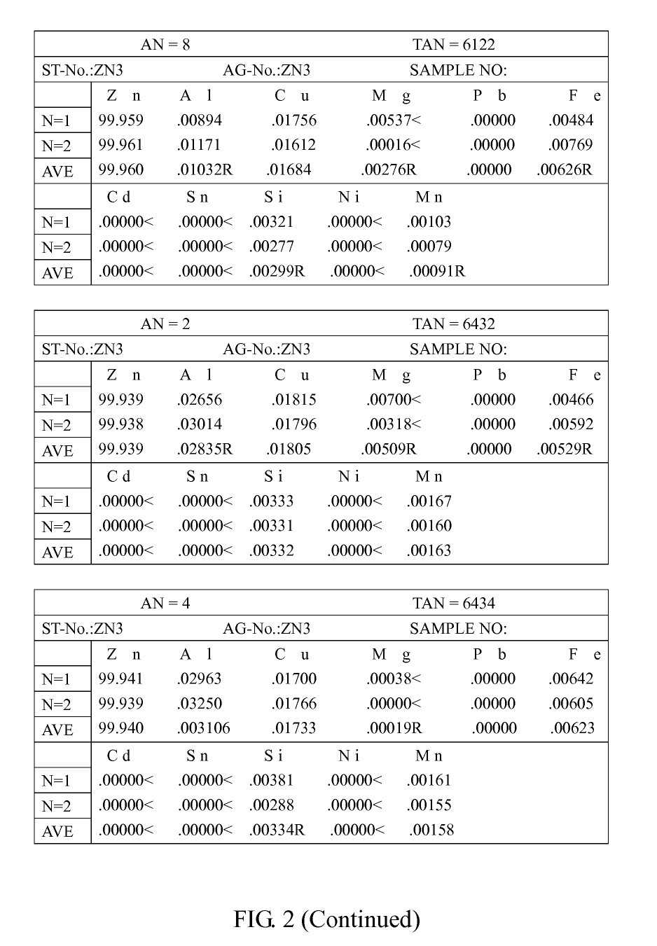

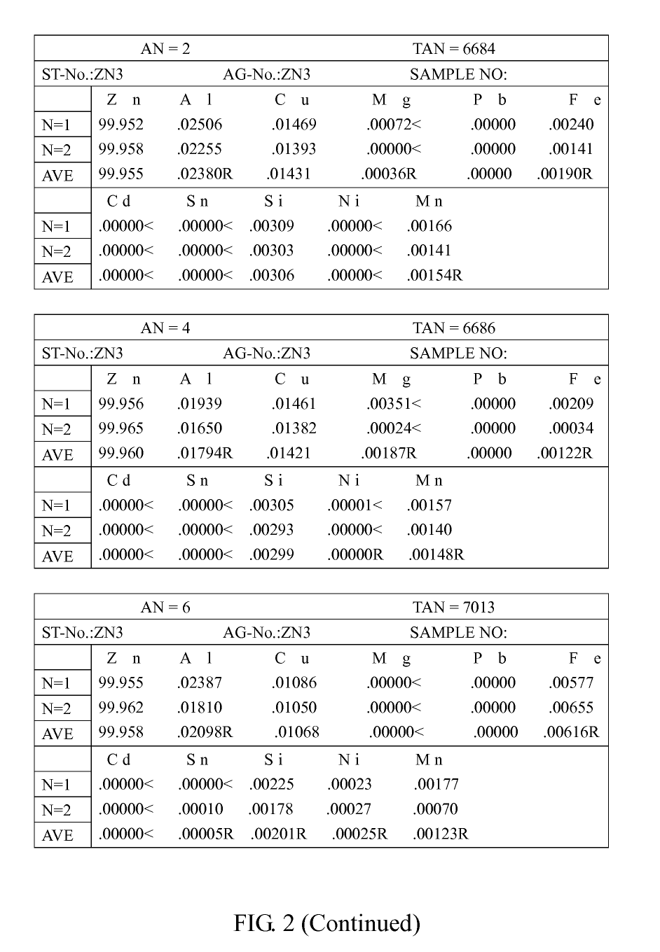

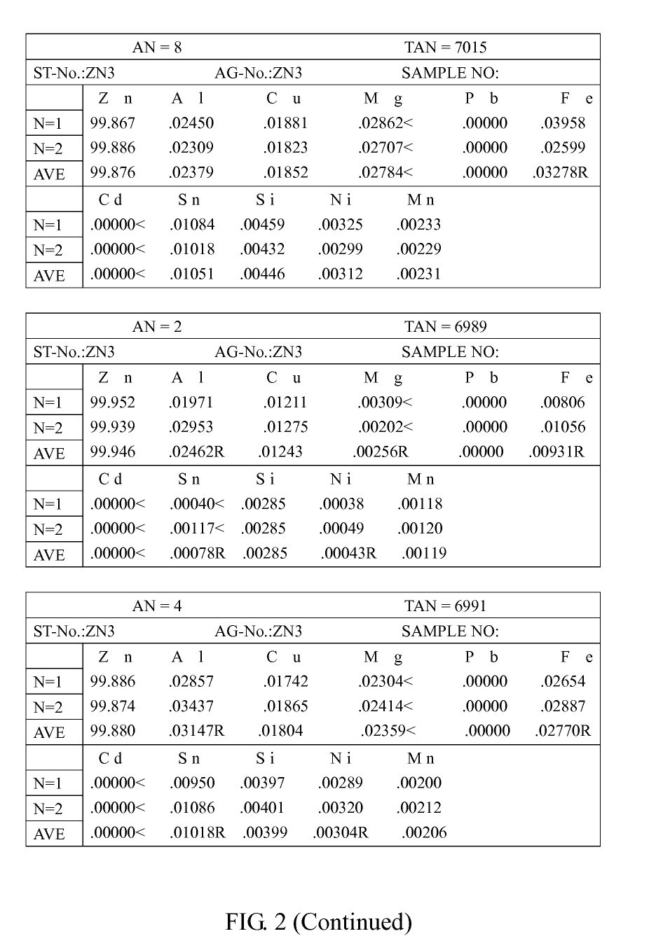

With reference to FIG. 2 for a product testing report of the present invention provided by SGS Taiwan and published in a public website, a hot-dip galvanized product manufactured in accordance with the present invention has a mass per unit area of over 600 g/m² without containing any lead or cadmium. The products suitable for hot-dip galvanizing are applied in steel plating, water piping, public utilities (such as road lamps, highway guard railing, and grating), factory facilities, steel structures, steel bars, steel grids, pipe fitting, greenhouse horticulture, expansion joints, piping, storage racks, universal corner steel, nuts and bolts.

Countries around the world have strict regulations on the control of lead. For example, European Union RoHS which took effect on Jul. 1, 2006, prohibits all conventional lead-containing hot-dip galvanized products from entering the European market. Thus, this lead-free galvanizing technology has becomes an important technical breakthrough.

1. The present invention can extend the life expectancy of a zinc bath furnace used in the conventional hot-dip galvanizing process, and improve the quality of galvanized products.

2. The present invention can reduce the production of waste material and assure the environment and operating site to be free of heavy-metal lead contamination, and thus the invention has significant economic benefits.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

In summation of the description above, the present invention improves over the prior art and complies with the patent application requirements, and thus is duly filed for patent application.

What is claimed is:

1. A lead-free hot-dip galvanizing method, provided for a manufacture according to an American Society for Testing and Materials (ASTM) specification, and said method using a hot-dip galvanizing zinc solution composed of a special high grade (SHG) zinc tablet, zinc, aluminum and less than 1% of a trace element.

2. The lead-free hot-dip galvanizing method of claim 1, wherein said special high grade (SHG) zinc tablet has a purity of 99.995%, said zinc solution containing 98 to 99% of zinc, 0.2 to 1.0% of aluminum measured by weight.

3. The lead-free hot-dip galvanizing method of claim 1, wherein said trace element is one selected from the collection of molybdenum, bismuth, silver, titanium and nickel.

4. A lead-free hot-dip galvanizing product, being a hot-dip galvanized steel plate manufactured by a hot-dip galvanizing zinc solution.

5. The lead-free hot-dip galvanizing product of claim 4, wherein said hot-dip galvanized steel plate having a mass per unit area of zinc greater than 600 g/m².

6. The lead-free hot-dip galvanizing product of claim 4, wherein said hot-dip galvanizing zinc solution being composed of 98% to 99% of zinc by weight, 0.2% to 1.0% of aluminum by weight, and less than 1% of a trace element by weight.

7. The lead-free hot-dip galvanizing product of claim 6, wherein said trace element is one selected from the collection of molybdenum, bismuth, silver, titanium and nickel.
